(19) United States
(12) Patent Application Publication
(10) Pub. No.: US 2022/0058789 A1
(43) Pub. Date: Feb. 24, 2022

(54) Method for Processing Infrared Image of Power Device Based on Measured Temperature

(71) Applicant: University of Electronic Science and Technology of China, Chengdu City (CN)

(72) Inventors: Yun ZHOU, Chengdu City (CN); Wuyi WANG, Chengdu City (CN); Longcheng QUE, Chengdu City (CN); Jian LV, Chengdu City (CN)

(73) Assignee: University of Electronic Science and Technology of China, Chengdu City (CN)

(21) Appl. No.: 17/409,733

(22) Filed: Aug. 23, 2021

(30) Foreign Application Priority Data
Aug. 24, 2020 (CN) 202010856862. X

(51) Int. Cl. G06T 7/00; G06K 9/62; G01J 5/00

(52) U.S. Cl. CPC G06T 7/0004; G06K 9/6232; G06K 9/6262; G01J 2005/0077; G06T 2207/10048; G06T 2207/20081; G01J 5/0096

(57) ABSTRACT

The present disclosure provides a method for processing an infrared image of a power device based on a measured temperature. The method includes: S1: acquiring grey data images of a power device at different environmental temperatures with an infrared thermal imager; and S2: constructing, according to the grey data images of the power device acquired at the different environmental temperatures with the infrared thermal imager in step S1, a machine learning (ML) temperature conversion model, and converting the grey data images at the different environmental temperatures into temperature data with the model. The method for processing an infrared image of a power device based on a measured temperature provided by the present disclosure greatly improves the practicability of the infrared image in the power device, and achieves a better processing effect than the conventional grey data imaging method.

### CROSS REFERENCE TO RELATED APPLICATION

This patent application claims the benefit and priority of Chinese Patent Application No. 202010856862. X filed on Aug. 24, 2020, the disclosure of which is incorporated by reference herein in its entirety as part of the present application.

### TECHNICAL FIELD

The present disclosure relates to the technical field of power device monitoring, and in particular, to a method for processing an infrared image of a power device based on a measured temperature.

### BACKGROUND ART

As an industry associated with the national interest and people's livelihood, the power industry plays an important role in economic development, social development and military development in China, and is also the basis for realizing the Made in China 2025. In order to meet national requirements of planning strategic resources overall, the domestic power infrastructures are optimized to keep up with the rapid development of smart power monitoring networks and accomplish the informatization management on the new power grid in a new era. The power system not only serves as a power conveyor in domestic markets, but also holds the primary responsibility to optimize the construction of domestic network infrastructures. Hence, the power safety supervision and the electrical safety in production are vital to our country. To supply the power reliably, novel power devices of an intensive type, an enclosed type, a miniature type, an oil-less type and so on are increasingly emerging. The power system is a complicated and crisscrossed system. Typically, a large area of power devices will be paralyzed in case of a fault in one component in the power system. Since insulating materials and enclosed structures are used, visual inspection, ear listening and the like for conventionally monitoring the power system have already been difficult to meet the demand for the stability of the power system. Every year, safety accidents arising from faults of the power devices account for 80% or more of power production safety accidents throughout the country, in which most of the faults are related to heat from current leakage, poor contact, loose connection and so on. Hence, effective monitoring on different types of power devices has become the researching hotspot. Till date, the communication technologies have been upgraded to the 3rd generation (3G) with image transmission, the 4th generation (4G) with video interaction, and the coming 5th generation (5G) with cloud services and Internet Plus, from the 2nd generation (2G) at which only text messages can be exchanged. The prosperous development of the era puts forward new requirements for network construction of the power system, and thus smart power stations are to be constructed urgently. Thanks to the development of electronic technologies and image technologies, power system monitoring technologies are also renewed constantly, with conventional substations developed toward the automation and automatic substations developed toward the digital intellectualization. For example, smart substations employ the communication technology and the electronic technology and integrate them into various primary devices and secondary devices, making the management and monitoring of substations develop to the unmanned and intelligent level.

In recent years, with the rapid development of infrared imaging technologies, related technologies are also increasingly applied in detection of the power devices to address numerous thermal faults of devices. The infrared thermography makes a detection based on thermal radiation of an object having a temperature above absolute zero and features non-contact, high sensitivity, no disturbance from an electric field, quick speed and desirable accuracy, etc. With the use of infrared radiation, infrared radiation energy on the surface of the object is measured as a temperature map. The infrared temperature measurement applied to online monitoring and inspection of a power distribution device is becoming the common means for reliable operation of the power system as it can timely predict and find the problems, effectively enhance the reliability and reduce the accidents. This is also the powerful tool for online real-time monitoring of the power system. In 1990, the international council on large electric systems (CIGRE) first affirmed the effect of thermography in diagnosis of the power devices. For the past few years, proactive measures have been taken to advance the research and applications of related technologies, and application guidelines have also been issued in China. Through the infrared thermography, thermal infrared radiation emitted from the power device can be transformed into thermal distribution images; and potential faults can be analyzed and determined with comparisons on the thermograms of the device. FIG. 1 illustrates features of an infrared image of the power device.

Although the conventional infrared image of the power device uses grey data for imaging, and the grey value on each point of the image corresponds to radiation energy emitted from the point on the measured object and reaching the photoelectric converter, the grey data of the image is not in one-to-one correspondence with the temperature values of the measured object at different environmental temperatures. Therefore, the conventional method for processing the infrared image of the power device has the poor effect, undesirable speed, etc.

### SUMMARY

For the technical problems that the existing method for processing the infrared image of the power device has the poor effect and undesirable speed and does not implement a one-to-one correspondence of the converted temperature data at different environmental temperatures, an objective of the present disclosure is to provide a method for processing an infrared image of a power device based on a measured temperature. The method implements the one-to-one correspondence between the converted image temperature data of the power device and the temperature values of the measured object at different environmental temperatures, such that the user can quickly find a temperature segment of interest at any workable environmental temperature. The present disclosure is novel, practicable, and able to process the infrared image of the power device with the good effect and fast speed.

The present disclosure is achieved by the following technical solutions.

A method for processing an infrared image of a power device based on a measured temperature includes the following steps:

S1: acquiring grey data images of a power device at different environmental temperatures with an infrared thermal imager; and

S2: constructing, according to the grey data images of the power device acquired at the different environmental temperatures with the infrared thermal imager in step S1, a machine learning (ML) temperature conversion model, and converting the grey data images at the different environmental temperatures into temperature data with the model.

The present disclosure improves the method for processing an infrared image of a power device based on a measured temperature. The present disclosure converts the grey into the temperature and processes the infrared image of the power device with the temperature, which greatly improves the practicability of the infrared image in the power device. Although the conventional infrared image of the power device uses the grey data for imaging, and the grey value on each point of the image corresponds to radiation energy emitted from the point on the measured object and reaching the photoelectric converter, the grey data of the image is not in one-to-one correspondence with the temperature values of the measured object at different environmental temperatures. The present disclosure implements the one-to-one correspondence between the converted image temperature data of the power device and the temperature values of the measured object at different environmental temperatures, such that the user can quickly find a temperature segment of interest at any workable environmental temperature. The present disclosure is novel, practicable, and able to process the infrared image of the power device with the good effect and fast speed.

Further, step S2 may include the following substeps:

S21: mapping the grey data images of the power device at the different environmental temperatures to object temperatures with the infrared thermal imager;

S22: searching a maximum temperature value and a minimum temperature value with a blind-pixel detection algorithm according to step S21, and removing a blind pixel and an overheated pixel; and

S23: establishing a temperature width color code on a temperature image pattern of the power device according to steps S21 and S22.

Further, step S21 may further include the following substeps:

S211: measuring object temperatures in a same scenario as step S1 with an infrared thermometer, and implementing a one-to-one correspondence between the object temperatures and the grey data images of the power device to form temperature data images of the power device;

S212: forming sample pairs with the temperature data images of the power device and the grey data images of the power device, and dividing the sample pairs into a training set and a test set according to a proportion of 7:3;

S213: constructing the ML temperature conversion model for a measured temperature; and

S214: performing parameter tuning and optimization on the model, training the model and testing the model.

Further, step S211 may specifically include:

implementing a one-to-one correspondence between grey data measured in step S1 and the object temperatures in a pixel relation to form the temperature data images of the power device, where a pixel value in the temperature data images of the power device represents a corresponding temperature value of an object on a pixel.

Further, step S213 may specifically include:

enabling the ML temperature conversion model to include three portions, where a first portion is a feature extraction module composed of one convolutional layer and one nonlinear activation layer; a second portion is a densely connected module; and a third portion is a reconstruction module composed of one convolutional layer.

Further, in the feature extraction module in step S213, the convolutional layer may include a convolution kernel having a size of 3×3, an initialized weight distribution of the convolution kernel may follow a Gaussian distribution, the grey data image of the power device may be taken as an input, a 64-channel feature map may be output, and the nonlinear activation layer may use a hyperbolic tangent (tanh) as an activation function.

Further, the densely connected module in step S213 may include three convolutional layers, where a batch normalization (BN) layer, a nonlinear activation layer and a 1×1 convolutional layer are embedded between every two convolutional layers; and the 64-channel feature map may be taken as an input, a 128-channel feature map may be output, a convolution kernel has a size of 3×3, an initialized weight distribution of the convolution kernel follows the Gaussian distribution, and the nonlinear activation layer uses a rectified linear unit (ReLU) as an activation function.

Further, in the reconstruction module in step S213, the convolutional layer may include a convolution kernel having a size of 3×3, an initialized weight distribution of the convolution kernel may follow the Gaussian distribution, the 128-channel feature map may be taken as an input, and the temperature data image of the power device may be output.

Further, step S214 may specifically include the following substeps:

constructing a loss function,

$${L}_{l o s s} = \frac{1}{N} {\sum }_{{ }^{j = 1}}^{N} {‖ F ( {I}_{g r e y}^{j} , θ ) - {I}_{t e m p}^{j} ‖}_{2}^{2} ,$$

where I_{grey}^{j} represents the grey data image of the power device input from the model, Iₜₑₘₚ^{j} represents an actual temperature data image of the power device, F (I_{grey}^{j}, θ) represents a trained temperature data image of the power device, θ represents a weight of the model, j represents each training sample pair, and N represents the number of samples in the training set;

step b: performing parameter tuning on each convolutional layer, selecting an appropriate optimizer to train the model, and storing a weight of a trained model; and

step c: loading the weight of the trained model, and testing the model with the test set.

Further, in step b, the model may be trained with an error back propagation algorithm and iteratively optimized by an Adam optimizer for 100,000 times in total, and a weight of an iteratively optimized model may be stored,

where, the Adam optimizer (as proposed by Diederik Kingma from the OpenAl and Jimmy Ba from the University of Toronto in a paper “Adam: A Method for Stochastic Optimization” submitted at the International Conference on Learning Representations (ICLR) 2015, Adam is a first-order optimization algorithm that can be used instead of the classical stochastic gradient descent procedure to update a weight of a neural network iteratively based on training data) is used to iteratively optimize the model for 100,000 times in total, and the weight of the iteratively optimized model is stored; and

the model obtained at this time can map the grey data at the different environmental temperatures to the object temperature data.

Further, step S22 may specifically include: searching the maximum temperature value and the minimum temperature value with the blind-pixel detection algorithm that is proposed by Li Liping et al. in an article “Novel Blind-Pixel Detection Algorithm for Infrared Focal Plane Arrays” in 2014, and removing the blind pixel and the overheated pixel.

As can be seen from the above descriptions of the present disclosure, the present disclosure has the following advantages and beneficial effects over the prior art:

1. The novelty of the present disclosure lies in: (1) Although the conventional infrared image of the power device uses the grey data for imaging, the grey data of the image does not implement the one-to-one correspondence at different environmental temperatures. The present disclosure implements the one-to-one correspondence of the converted temperatures at the different environmental temperatures, such that the user can quickly find a temperature segment of interest at any workable environmental temperature. (2) The present disclosure provides the ML temperature conversion model which can map the infrared grey data image of the power device to the infrared temperature data image, thereby meeting the real-time requirement. (3) The present disclosure is novel, practicable, and able to process the infrared image of the power device with the good effect and fast speed.

2. The present disclosure converts the grey into the temperature and processes the infrared image of the power device with the temperature, thereby achieving a better treatment effect than the conventional method. Meanwhile, the present disclosure converts the grey data into the temperature data and implements the one-to-one correspondence of the converted temperature data at the different environmental temperatures. The present disclosure is novel, practicable, and able to process the infrared image of the power device with the good effect and fast speed.

### BRIEF DESCRIPTION OF THE DRAWINGS

The accompanying drawings described herein are provided for further understanding on the embodiments of the present disclosure, and constitute a part of this application rather than a limit to the embodiments of the present disclosure. In the drawings:

FIG. 1 illustrates a schematic view of an image of an infrared thermometer.

FIG. 2 illustrates a flow chart of a method for processing an infrared image of a power device based on a measured temperature according to the present disclosure.

FIG. 3 illustrates a diagram of an ML temperature conversion model constructed for a measured temperature according to a method of the present disclosure.

FIG. 4 illustrates a diagram of a densely connected module in an ML temperature conversion model according to the present disclosure.

FIG. 5 illustrates an image block stochastically taken from a conventional infrared image of a power device according to the present disclosure.

FIG. 6 illustrates a histogram of a test result according to the present disclosure, (a) being a histogram of grey data, and (b) being a histogram of temperature data after test.

### DETAILED DESCRIPTION OF THE EMBODIMENTS

In order to make the objectives, technical solutions, and advantages of the present disclosure more apparent, the present disclosure will be further described in detail below with reference to the embodiments and accompanying drawing. The exemplary implementations and descriptions thereof in the present disclosure are only used to explain the present disclosure, and are not intended to limit the present disclosure.

In the following descriptions, numerous particular details are set forth in order to provide a thorough understanding of the present disclosure. However, it will be apparent to a person of ordinary skill in the art that the present disclosure is implemented unnecessarily with these details. In other examples, well known structures, circuits, materials or methods have not been described in detail in order to avoid obscuring the present disclosure.

Reference throughout this specification to “one embodiment”, “an embodiment”, “one example” or “an example” means that a particular feature, structure, or characteristic described in connection with the embodiment or example is included in at least one embodiment of the present disclosure. Thus, the appearances of the phrases “one embodiment”, “an embodiment”, “one example” or “an example” in various places throughout this specification are not necessarily all referring to the same embodiment or example. Furthermore, the particular features, structures, or characteristics may be combined in any suitable combination and/or sub-combination in one or more embodiments or examples. In addition, it should be understood by the person of ordinary skill in the art that the drawings provided herein are illustrative only but are unnecessarily drawn according to a proportion. As used herein, the term “and/or” includes any and all combinations of one or more related items listed.

In the description of the present disclosure, it should be understood that orientations or positional relationships indicated by the terms “front”, “rear”, “left”, “right”, “upper”, “lower”, “vertical”, “horizontal”, “high”, “low”, “inner”, “outer” and the like are based on the orientations or positional relationships as shown in the drawings, for ease of describing the present disclosure and simplifying the description only, rather than indicating or implying that the indicated device or element must have a particular orientation or be constructed and operated in a particular orientation. Therefore, these terms should not be understood as a limitation to the protection scope of the present disclosure.

### EMBODIMENTS

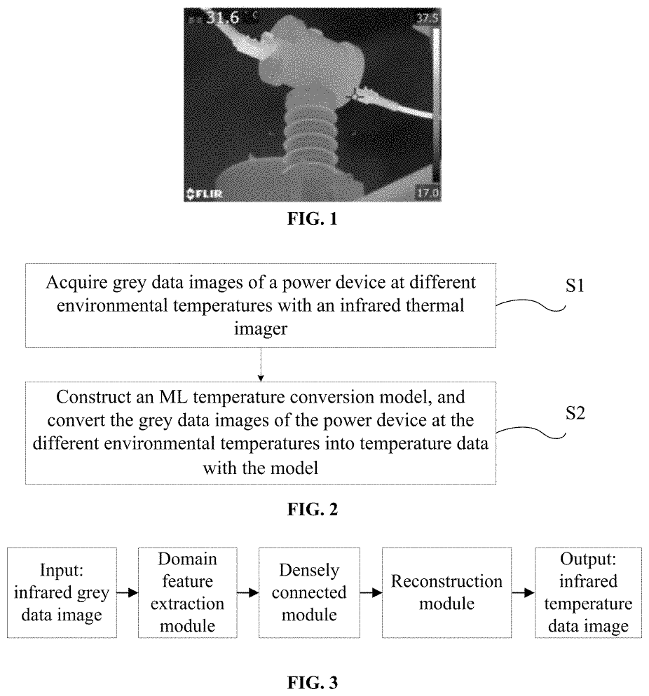

FIGS. 1 to 4 illustrate a method for processing an infrared image of a power device based on a measured temperature. As shown in FIG. 2, the method includes the following steps:

S1: Acquiring grey data images of a power device with an infrared thermal imager at different environmental temperatures.

S2: Constructing, according to the grey data images of the power device acquired with the infrared thermal imager at the different environmental temperatures in Step S1, an ML temperature conversion model, and converting the grey data images of the power device at the different environmental temperatures into temperature data with the model.

Specifically, Step S2 includes the following substeps:

S21: Mapping the grey data images of the power device at the different environmental temperatures to object temperatures with the infrared thermal imager.

S22: Searching a maximum temperature value and a minimum temperature value with a blind-pixel detection algorithm according to Step S21, and removing a blind pixel and an overheated pixel.

S23: Establishing a temperature width color code on a temperature data image pattern of the power device according to Steps S21 and S22 for later use.

Specifically, Step S21 includes the following substeps:

S211: Measuring object temperatures in the same scenarios as Step S1 with an infrared thermometer, and implementing a one-to-one correspondence between the object temperatures and the grey data images of the power device to form temperature data images of the power device.

S212: Forming sample pairs with the temperature data images of the power device and the grey data images of the power device, and dividing the sample pairs into a training set and a test set according to a proportion of 7:3.

S213: Constructing the ML temperature conversion model for a measured temperature.

S214: Performing parameter tuning and optimization on the model, training the model and test the model.

Specifically, Step S211 specifically includes:

Implementing a one-to-one correspondence between grey data measured in Step S1 and the object temperatures in pixel relation to form the temperature data images of the power device, where a pixel value in the temperature data images of the power device represents a corresponding temperature value of an object on a pixel.

Specifically, Step S213 may be specifically implemented as follows.

As shown in FIG. 3, the ML temperature conversion model includes three portions, where a first portion is a feature extraction module composed of one convolutional layer and one nonlinear activation layer; a second portion is a densely connected module; and a third portion is a reconstruction module composed of one convolutional layer.

Specifically, in the feature extraction module in Step S213, the convolutional layer includes a convolution kernel having a size of 3×3, an initialized weight distribution of the convolution kernel follows a Gaussian distribution, the grey data image of the power device is taken as the input, a 64-channel feature map is output, and the nonlinear activation layer uses a tanh as an activation function.

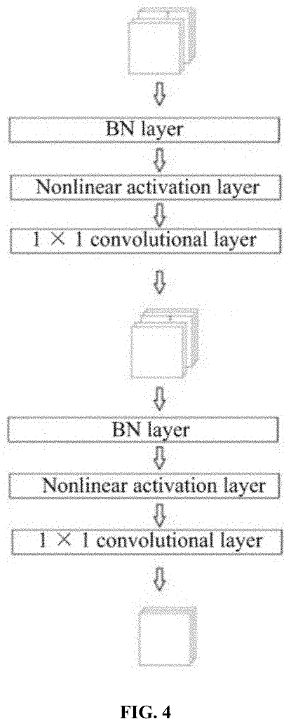

Specifically, in Step S213, as shown in FIG. 4, the densely connected module includes three convolutional layers, where a BN layer, a nonlinear activation layer and a 1×1 convolutional layer are embedded between every two convolutional layers; and the 64-channel feature map is taken as the input, a 128-channel feature map is output, a convolution kernel has a size of 3×3, an initialized weight distribution of the convolution kernel follows the Gaussian distribution, and the nonlinear activation layer uses an ReLU as an activation function.

Specifically, in the reconstruction module in Step S213, the convolutional layer includes a convolution kernel having a size of 3×3, an initialized weight distribution of the convolution kernel follows the Gaussian distribution, the 128-channel feature map is taken as the input, and the temperature data image of the power device is output.

Specifically, Step S214 specifically includes the following substeps:

Constructing a loss function,

$${L}_{l o s s} = \frac{1}{N} {\sum }_{{ }^{j = 1}}^{N} {‖ F ( {I}_{g r e y}^{j} , θ ) - {I}_{t e m p}^{j} ‖}_{2}^{2} ,$$

where I_{grey}^{j} represents the grey data image of the power device input from the model, Iₜₑₘₚ^{j} represents an actual temperature data image of the power device, F (I_{grey}^{j}, θ) represents a trained temperature data image of the power device, θ represents a weight of the model, j represents each training sample pair, and N represents the number of samples in the training set.

Step b: Performing parameter tuning on each convolutional layer, selecting an appropriate optimizer to train the model, and storing a weight of a trained model.

Step c: Loading the weight of the trained model, and testing the model with the test set.

Specifically, in Step b, the model is trained with an error back propagation algorithm and iteratively optimized by an Adam optimizer for 100,000 times in total, and a weight of an iteratively optimized model is stored.

The Adam optimizer (as proposed by Diederik Kingma from the OpenAl and Jimmy Ba from the University of Toronto in a paper “Adam: A Method for Stochastic Optimization” submitted at the ICLR 2015, Adam is a first-order optimization algorithm that can be used instead of the classical stochastic gradient descent procedure to update a weight of a neural network iteratively based on training data) is used to iteratively optimize the model for 100,000 times in total, and the weight of the iteratively optimized model is stored.

The model obtained at this time can map the grey data at the different environmental temperatures to the object temperature data.

Further, Step S22 specifically includes: searching the maximum temperature value and the minimum temperature value with the blind-pixel detection algorithm that is proposed by Li Liping et al. in an article “Novel Blind-Pixel Detection Algorithm for Infrared Focal Plane Arrays” in 2014, and removing the blind pixel and the overheated pixel.

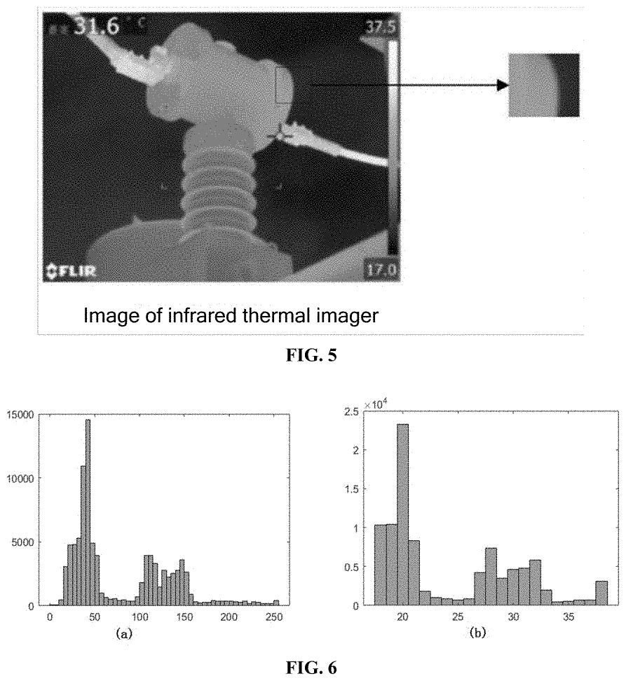

According to the above steps, an image block is stochastically intercepted from the conventional infrared image of the power device, as shown in FIG. 5. The grey data of the image block is as shown in Table 1, and each value in Table 1 represents a pixel grey value of the image block intercepted in FIG. 5. With the method of the present disclosure, the infrared image (FIG. 5) is input to the model, the model outputs the corresponding temperature data image of the power device, a temperature data image block is intercepted at a position same as the position to which the previously intercepted grey data image block corresponds, and the pixel value of the intercepted temperature data image block is as shown in Table 2. The grey data image is mapped to the temperature data image by the model, and the corresponding grey pixel value 121 (as shown by the grey number in Table 1) is mapped to the temperature pixel value 26 (as shown by the grey number in Table 2). Therefore, the pixel value of the temperature data image is in one-to-one correspondence with the measured actual temperature.

As can be seen, although the conventional infrared image of the power device uses the grey data for imaging, the grey value on each point of the image and the temperature value of the measured object are not in one-to-one correspondence, unless mapping relations under different environments are established. However, the converted image temperature data (Table 2) of the power device is in one-to-one correspondence with the temperature value of the measured object, such that the user can quickly find a temperature segment of interest at any workable environmental temperature.

FIG. 6 illustrates a histogram of a test result according to the present disclosure, (a) being a histogram of grey data, and (b) being a histogram of temperature data after test, where the (a) histogram is plotted with the pixel value of the grey image as the horizontal axis and the frequency that the pixel value occurs as the vertical axis, and the (b) histogram is plotted with the pixel value of the temperature image obtained after the test as the horizontal axis, and the frequency that the pixel value occurs as the vertical axis.

The present disclosure improves the method for processing an infrared image of a power device based on a measured temperature. The present disclosure converts the grey into the temperature and processes the infrared image of the power device with the temperature, which greatly improves the practicability of the infrared image in the power device, and achieves a better processing effect than the conventional grey data imaging method. Although the conventional infrared image of the power device uses the grey data for imaging, and the grey value on each point of the image corresponds to radiation energy emitted from the point on the measured object and reaching the photoelectric converter, the grey data of the image of the power device is not in one-to-one correspondence with the temperature values of the measured object at different environmental temperatures. The present disclosure implements the one-to-one correspondence between the converted image temperature data of the power device and the temperature values of the measured object at the different environmental temperatures, such that the user can quickly find a temperature segment of interest at any workable environmental temperature.

The present disclosure provides the ML temperature conversion model which can map the infrared grey data image of the power device to the infrared temperature data image of the power device, thereby meeting the real-time requirement. The present disclosure is novel, practicable, and able to process the infrared image of the power device with the good effect and fast speed.

The method of the present disclosure is applied to processing different infrared images of the power device and converting the grey data images at the different environmental temperatures into the temperature data. The present disclosure implements the one-to-one correspondence between the converted image temperature data of the power device and the temperature values of the measured object at the different environmental temperatures, such that the user can quickly find a temperature segment of interest at any workable environmental temperature.

The objectives, technical solutions, and beneficial effects of the present disclosure are further described in detail in the foregoing specific implementations. It should be understood that the foregoing descriptions are merely specific implementations of the present disclosure, but are not intended to limit the protection scope of the present disclosure. Any modification, equivalent replacement, improvement, or the like made within the spirit and principle of the present disclosure shall fall within the protection scope of the present disclosure.

What is claimed is:

1. A method for processing an infrared image of a power device based on a measured temperature, comprising the following steps:
S1: acquiring grey data images of a power device at different environmental temperatures with an infrared thermal imager; and
S2: constructing, according to the grey data images of the power device acquired at the different environmental temperatures with the infrared thermal imager in step S1, a machine learning (ML) temperature conversion model, and converting the grey data images at the different environmental temperatures into temperature data with the model.

2. The method for processing an infrared image of a power device based on a measured temperature according to claim 1, wherein step S2 comprises the following substeps:
S21: mapping the grey data images of the power device at the different environmental temperatures to object temperatures with the infrared thermal imager;
S22: searching a maximum temperature value and a minimum temperature value with a blind-pixel detection algorithm according to step S21, and removing a blind pixel and an overheated pixel; and
S23: establishing a temperature width color code on a temperature data image pattern of the power device according to steps S21 and S22.

3. The method for processing an infrared image of a power device based on a measured temperature according to claim 2, wherein step S21 comprises the following substeps:
S211: measuring object temperatures in a same scenario as step S1 with an infrared thermometer, and implementing a one-to-one correspondence between the object temperatures and the grey data images to form temperature data images of the power device;
S212: forming sample pairs with the temperature data images and the grey data images of the power device, and dividing the sample pairs into a training set and a test set;
S213: constructing the ML temperature conversion model for a measured temperature; and
S214: performing parameter tuning and optimization on the model, training the model and testing the model.

4. The method for processing an infrared image of a power device based on a measured temperature according to claim 3, wherein step S211 specifically comprises:
implementing a one-to-one correspondence between grey data measured in step S1 and the object temperatures in a pixel relation to form the temperature data images of the power device, wherein a pixel value in the temperature data images represents a corresponding temperature value of an object on a pixel.

5. The method for processing an infrared image of a power device based on a measured temperature according to claim 3, wherein step S213 specifically comprises:
enabling the ML temperature conversion model to comprise three portions, wherein a first portion is a feature extraction module composed of one convolutional layer and one nonlinear activation layer; a second portion is a densely connected module; and a third portion is a reconstruction module composed of one convolutional layer.

6. The method for processing an infrared image of a power device based on a measured temperature according to claim 5, wherein in the feature extraction module in step S213, the convolutional layer comprises a convolution kernel having a size of 3×3, an initialized weight distribution of the convolution kernel follows a Gaussian distribution, the grey data image of the power device is taken as an input, a 64-channel feature map is output, and the nonlinear activation layer uses a hyperbolic tangent (tanh) as an activation function.

7. The method for processing an infrared image of a power device based on a measured temperature according to claim 5, wherein the densely connected module in step S213 comprises three convolutional layers, wherein a batch normalization (BN) layer, a nonlinear activation layer and a 1×1 convolutional layer are embedded between every two convolutional layers; and the 64-channel feature map is taken as an input, a 128-channel feature map is output, a convolution kernel has a size of 3×3, an initialized weight distribution of the convolution kernel follows the Gaussian distribution, and the nonlinear activation layer uses a rectified linear unit (ReLU) as an activation function.

8. The method for processing an infrared image of a power device based on a measured temperature according to claim 5, wherein in the reconstruction module in step S213, the convolutional layer comprises a convolution kernel having a size of 3×3, an initialized weight distribution of the convolution kernel follows the Gaussian distribution, the 128-channel feature map is taken as an input, and the temperature data image is output.

9. The method for processing an infrared image of a power device based on a measured temperature according to claim 5, wherein step S214 specifically comprises the following substeps:
step a: constructing a loss function,
$${L}_{l o s s} = \frac{1}{N} {\sum }_{{ }^{j = 1}}^{N} {‖ F ( {I}_{{ }^{grey}}^{j} , θ ) - {I}_{t e m p}^{j} ‖}_{2}^{2} ,$$
where I_{grey}^{j} represents the grey data image of the power device input from the model, Iₜₑₘₚ^{j} represents an actual temperature data image of the power device, F (I_{grey}^{j}, θ) represents a trained temperature data image of the power device, θ represents a weight of the model, j represents each training sample pair, and N represents the number of samples in the training set;
step b: performing parameter tuning on each convolutional layer, selecting an appropriate optimizer to train the model, and storing a weight of a trained model; and
step c: loading the weight of the trained model, and testing the model with the test set.

10. The method for processing an infrared image of a power device based on a measured temperature according to claim 9, wherein in step b, the model is trained with an error back propagation algorithm and iteratively optimized by an Adam optimizer for 100,000 times in total, and a weight of an iteratively optimized model is stored.
